(19) United States
(12) Patent Application Publication
(10) Pub. No.: US 2026/0046806 A1
(43) Pub. Date: Feb. 12, 2026

(54) LOCATION FUSING ON LOCATION MANAGEMENT FUNCTION

(71) Applicant: Cisco Technology, Inc., San Jose, CA (US)

(72) Inventors: Gino Michele Corleto, Pattensen (GE); Malcolm M. Smith, Richardson, TX (US); Indermeet Singh Gandhi, San Jose, CA (US); Binita Gupta, San Diego, CA (US); Alan W. Dumdei, Greenville, TX (US); Sukanya Nutakki, Frisco, TX (US)

(21) Appl. No.: 18/800,267

(22) Filed: Aug. 12, 2024

(51) Int. Cl. H04W 64/00

(52) U.S. Cl. CPC H04W 64/00

(57) ABSTRACT

An approach to track a location of a mobile device is provided. A method includes, from a cellular network element, sending a first query to a mobile device requesting position determining capabilities of the mobile device, in response to the first query, receiving, from the mobile device, information sufficient to contact a controller element of a positioning service for the mobile device, from the cellular network element, sending a second query to the controller element of the positioning service for data representative of coordinates of fixed assets used for the positioning service, and in response to the second query, receiving from the controller element the data representative of the coordinates of fixed assets used for the positioning service.

### TECHNICAL FIELD

The present disclosure relates to locating a mobile device within one or more wireless network infrastructures.

### BACKGROUND

Knowing the location of a mobile device that is accessing a wireless network may be useful for many applications including, for example, emergency calls, personal navigation, asset tracking, locating a friend or family member, etc. Wireless networks may include cellular networks, e.g., Fifth Generation (5G) networks, and Wireless Local Area Networks (WLANs), among others, each having its own unique Radio Access Technology (RAT). Each such RAT may also offer different client/device real time locating systems (RTLSs) that rely on various underlying mechanisms including signal Angle of Arrival (AOA), Ultra-Wideband (UWB) ranging mechanisms, Global Positioning System (GPS), and 5G Location Management Function (LMF) capabilities, among others. Notably, one location determining method or RTLS method may be better than another, depending on any number of variables, including aspects of the physical environment, distance from an Access Point (AP)/gNodeB or other fixed asset, and radio frequency (RF) dynamics at any given moment in time.

### BRIEF DESCRIPTION OF THE DRAWINGS

FIG. 1 shows an arrangement including a cellular network including a core network function server that executes location management function logic, according to an example embodiment.

FIG. 2 shows a plurality of real time location service data sources that may be aggregated at a converged location data database associated with location management function logic, according to an example embodiment.

FIG. 3 shows communication among location management function logic, a wireless local area network controller, access points, other fixed assets, and a mobile device, according to an example embodiment.

FIG. 4 is a ladder diagram illustrating exchanges between a server hosting location management function logic and a mobile device, according to an example embodiment.

FIG. 5 is a ladder diagram illustrating exchanges among location management function logic, a mobile device, and a wireless local area network controller, according to an example embodiment.

FIG. 6 shows a database used by location management function logic to select and or fuse location information received from a mobile device, according to an example embodiment.

FIG. 7 is a flowchart depicting a series of operations that may be executed by location management function logic, according to an example embodiment.

FIG. 8 is a block diagram of a computing device that may be configured to host location management function logic, and to perform techniques described herein, according to an example embodiment.

### DETAILED DESCRIPTION

### Overview

An approach to track a location of a mobile device is provided. A method includes, from a wireless network element, sending to a mobile device a first query requesting position determining capabilities of the mobile device, in response to the first query, receiving, from the mobile device, information sufficient to communicate with a controller element of a positioning service for the mobile device, from the wireless network element, sending to the controller element of the positioning service a second query for data representative of coordinates of fixed assets used for the positioning service, and in response to the second query, receiving from the controller element the data representative of the coordinates of fixed assets used for the positioning service.

A device is also described and includes an interface configured to enable network communications, a memory, and one or more processors coupled to the interface and the memory, and configured to: send to a mobile device a first query requesting position determining capabilities of the mobile device, in response to the first query, receive, from the mobile device, information sufficient to communicate with a controller element of a positioning service for the mobile device, send to the controller element of the positioning service a second query for data representative of coordinates of fixed assets used for the positioning service, and in response to the second query, receive from the controller element the data representative of the coordinates of fixed assets used for the positioning service.

### Example Embodiments

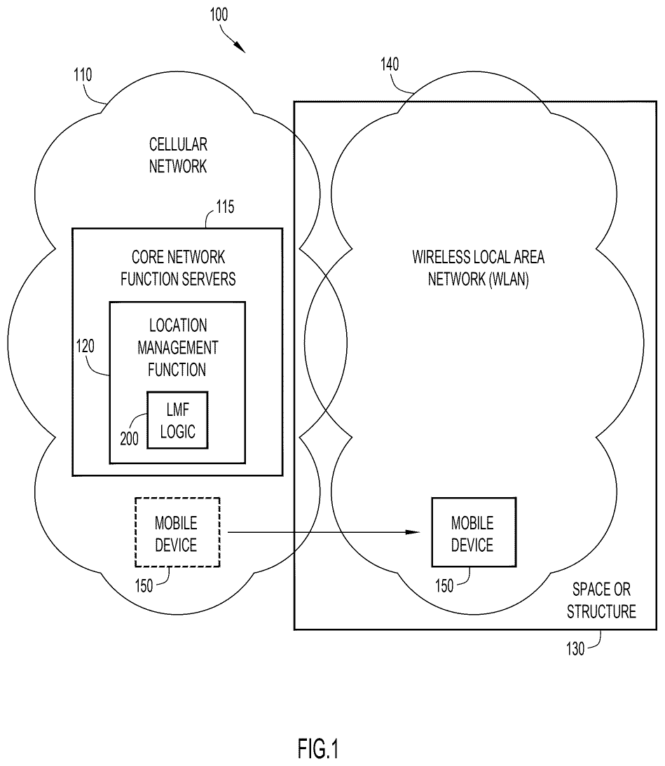

FIG. 1 shows a system 100 including a cellular network 110 that executes location management function logic, or LMF logic 200, according to an example embodiment. More specifically, FIG. 1 shows a portion of a 5G cellular network 110 including core network function servers 115 that may host, among other possible functions, an Access and Mobility Management Function (AMF), Session Management Function (SMF), User Plane Function (UPF), Network Exposure Function (NEF), NR Repository Function (NRF), Network Slice Selection Function (NSSF), Unified Data Function (UDM), Authentication Server Function (AUSF), Policy Control Function (PCF), Application Function (AF), and Location Management Function (LMF) 120. LMF logic 200 may be hosted by LMF 120, i.e., a core network function server.

A space or structure (referred to as “space 130”) may be served by a wireless local area network (WLAN) 140, and/or other infrastructure as further described below. As shown, a mobile device 150 may move from the cellular network 110 into the space 130. Alternatively, the mobile device 150 may always be located within space 130. In either case, mobile device 150 may lose, or never have contact with, a positioning/location system such as a Global Positioning System (GPS), and cellular network 110 may not be able to track the location of mobile device 150.

Notably, it may be desirable, especially in the case of a private 5G network, to continually monitor the location or position of mobile device 150. For example, one possible Application Function (AF) of cellular network 110 may be a location-based service (inventory control, robot control, etc.) that the cellular network 110 might want to provide. The embodiments described herein enable cellular network 110, and particularly LMF logic 200, to track a location of mobile device 150 in space 130.

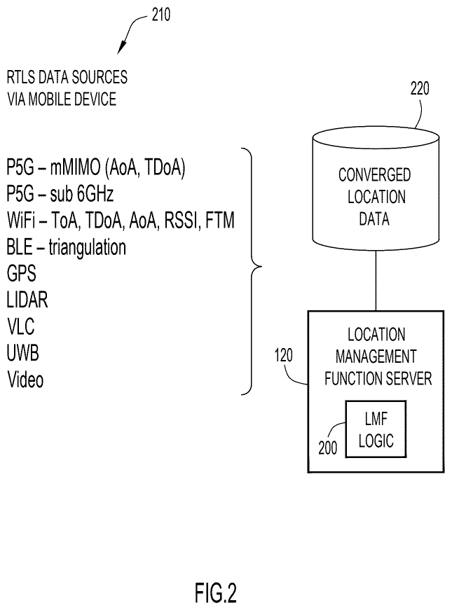

FIG. 2 shows a plurality of real time location service (RTLS) data sources 210, operable with mobile device 150, that may be aggregated at a converged location data database 220 associated with LMF logic 200, according to an example embodiment. That is, as will be explained more fully below, LMF logic 200 is configured to receive or collect different forms of RTLS data from different systems, select one such form of data, or fuse different forms of such data, to determine a location of mobile device 150 within space 130. The following are examples of systems or infrastructure that may provide RTLS data, which may be collected by LMF logic 200 via converged location data database 220.

Private 5G (P5G) may provide massive multiple-input multiple-output (mMIMO) and associated Angle of Arrival (AoA) and Time Difference of Arrival (TDoA) data.

P5G may also provide sub 6GHz positioning data.

A WLAN (e.g., Wi-Fi® wireless network) may provide Time of Arrival (ToA), TDoA, AOA, Received Signal Strength (RSSI), Fine Time Measurement (FTM) data.

Bluetooth® Low Energy (BLE) may provide triangulation data.

A GPS can provide direct location information.

Light Detection and Ranging (LIDAR) systems may provide position data.

Visible Light Communication (VLC) systems can provide position data.

Ultra Wideband (UWB) systems may be used to obtain ranging data.

Video and imaging systems can be used to obtain position data.

Each of the foregoing capabilities employs different infrastructure outside and/or inside space 130. For example, WLAN 140 may employ a plurality of Access Points that can be leveraged to provide position information for mobile device 150. Likewise, LIDAR and VLC may use fixed light sources to determine a position of mobile device 150. No matter the case, position data generated by infrastructure outside and/or inside of space 130 may, in accordance with an embodiment, be supplied to converged location data database 220, which is in communication with LMF logic 200, as shown in FIG. 2. In an embodiment, the position data may be in a raw format. That is, the data may not directly indicate a specific world coordinate location (e.g., latitude/longitude (lat/long)) of mobile device 150, but may instead indicate a relative position of mobile device 150 within space 130 with respect to Access Points or other fixed assets. LMF logic 200 may then process that data, including fusing data received from two or more RTLSs, to determine an accurate location of mobile device 150. The use and/or fusing of multiple sources of position data may be referred to as “Multi-Mode Fusion” for selected devices that have “Multi-Mode Fusion Capability” or “MMFC.”

There are many use cases for location or position data convergence using Multi-Mode Fusion. For example, a 5G cellular infrastructure can have native abilities to detect location but these may not be accurate enough for selected applications. Consider a scenario in which a user of mobile device 150 would like to have food delivered to their location. Perhaps the user is located at a slot machine in a casino, i.e., the space 130. Because the mobile device 150 is located indoors, GPS is likely unhelpful. Nevertheless, the network can provide information about the building in which the mobile device 150 is located. In this regard, and in accordance with an embodiment, the mobile device 150 may be configured to support MMFC and thus can acquire location or position measurements using other RTLS methods and pass that data back to the cellular infrastructure. Specifically, space 130 (the casino) may offer Wi-Fi and the mobile device 150 may obtain ranging information or location information from that network. There may even be more specific location capabilities within a room in space 130. For example, mobile device 150 may be UWB capable.

Another use case for outdoor and indoor position or location data fusion can be found in logistics and warehouse scenarios. While goods may be transported and tracked outdoors with GPS and 5G location tracking, indoors the goods may be tracked by P5G and other wireless technologies based on needed location preciseness and requirements. Such location information fusion enables end-to-end tracking of goods or produced materials. In manufacturing, such an approach can support important business processes for material flow, better quality, and shorter time to market.

In accordance with the embodiments described herein, LMF logic 200 may first determine if mobile device 150 is configured with MMFC and, if so, LMF logic 200 may then query the mobile device 150 for position/location information generated by multiple RTLS methods. The resulting location determined by LMF logic 200 can then be provided as an input to applications such as E911, product tracking systems, etc., that rely on accurate location information.

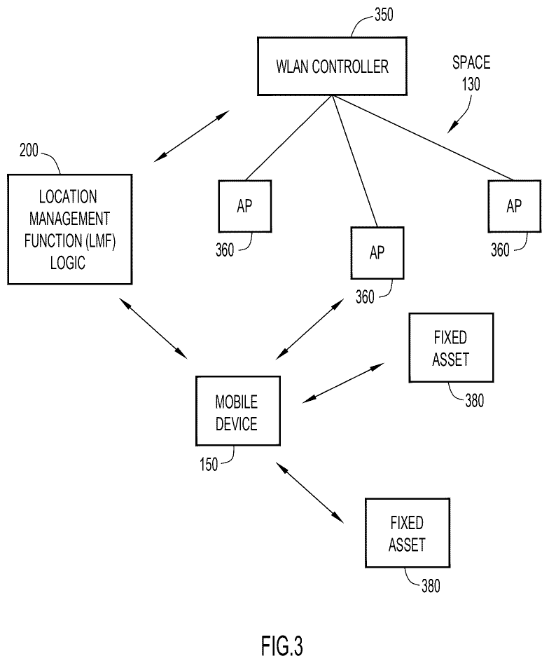

FIG. 3 shows communication among LMF logic 200, a wireless local area network controller, or WLAN Controller 350, Access Points, or APs 360, other fixed assets 380, and mobile device 150, according to an example embodiment. More specifically, mobile device 150 is shown within space 130. In this case, mobile device 150 may communicate with one or more APs 360, which are themselves in communication with WLAN Controller 350. Mobile device 150 may also be able to communicate with, or coordinate with, one or more other fixed assets 380 that may be deployed in space 130. For example, fixed assets 380 may include a light, a marker, a camera, etc., with a known location. In this regard, APs 360 may also be considered a form of fixed asset 380 since their respective locations are often known as well. Together, the collection of fixed assets 380 (including APs 360) for each given form of RTLS or positioning capability may be represented by a map or “constellation” that indicates where in space 130 each individual fixed asset 380 (including each of APs 360) is located (perhaps by lat/long).

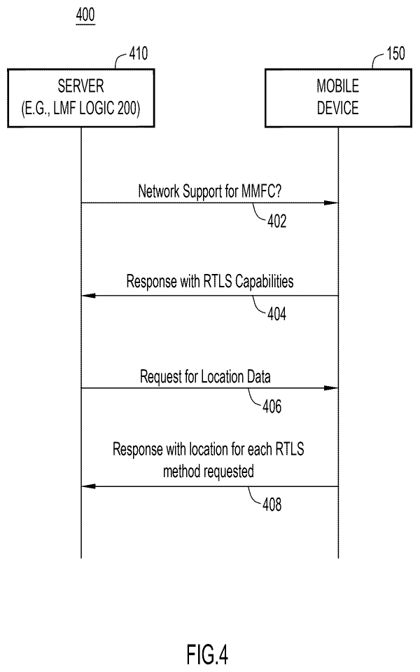

FIG. 4 is a ladder diagram 400 illustrating exchanges between a server 410 that may host LMF logic 200 and mobile device 150, according to an example embodiment. FIG. 4 is described with reference to FIG. 3 as well. As shown, a server 410, such as a server hosting LMF logic 200, is in communication with mobile device 150. In one embodiment, the communication exchanges between these two entities are via non-access stratum (NAS). However, those skilled in the art will appreciate that any communication link between server 410 and mobile device 150 may be implemented to enable the exchanges described herein.

As further shown, at 402, server 410 sends a query to mobile device 150 regarding whether mobile device 150 supports MMFC (i.e., can mobile device supply RTLS data for one or more RTLSs). If yes, at 404, mobile device 150 responds with its RTLS capabilities. In this case, the RTLS capabilities may be limited to capabilities that provide actual world coordinates (lat/long) of mobile device 150 in space 130. Such RTLS capabilities might include GPS data, among others. At 406, server 410 requests location data from mobile device 150, in accordance with the one or more RTLS capabilities indicated by mobile device 150. That is, server 410 may request location data for each of the RTLS capabilities indicated as being supported by mobile device 150 or may, instead, request location data in connection with a subset of RTLS capabilities indicated as being supported by mobile device 150. In response to the request for location data at 406 for selected or all of the RTLS capabilities, mobile device 150, at 408, sends to server 410 location data for each RTLS method requested. The data may be sent in a table format with each RTLS method listed separately along with corresponding location data (e.g., lat/long). Thus, in the case of the embodiment of FIG. 4, LMF logic 200 requests location data from mobile device 150, and mobile device 150 itself provides its location, perhaps from multiple RTLSs.

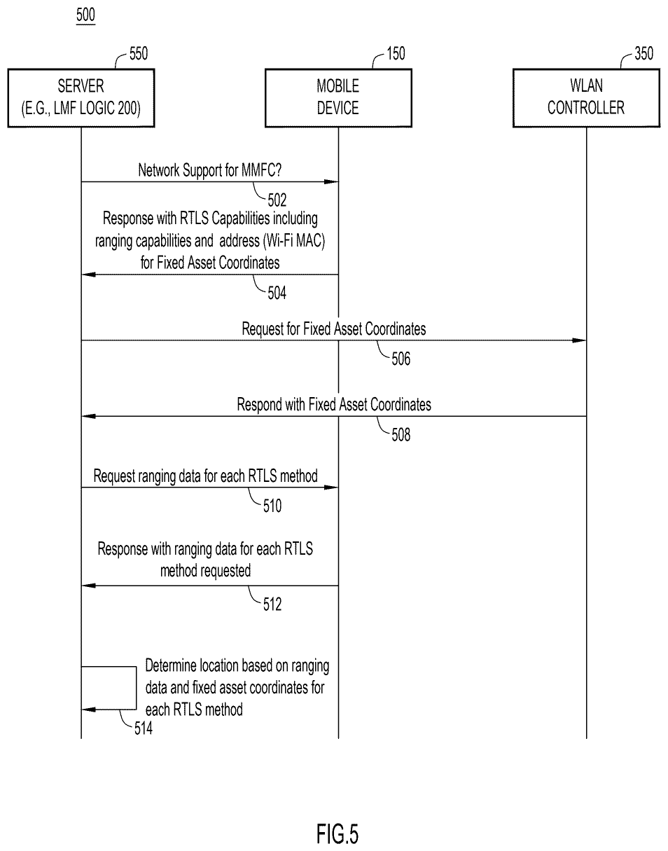

FIG. 5 is a ladder diagram 500 illustrating exchanges among a server 550 that may host LMF logic 200, mobile device 150, and WLAN Controller 350, according to an example embodiment. FIG. 5 is also described with reference to FIG. 3. At 502, server 550 sends a query to mobile device 150 asking whether mobile device 150 supports MMFC. At 504, mobile device 150 responds with its RTLS capabilities, including ranging capabilities, and an address for fixed asset coordinates associated with its ranging capabilities. For example, mobile device 150 may supply server 550 with a MAC or IP address of WLAN Controller 350, which stores the map or constellation coordinates for APs 360.

It is noted that the methodology illustrated by FIG. 5 is different from that illustrated by FIG. 4 in that, in the case of FIG. 5, actual location or (lat/long) coordinates of mobile device 150 itself are not provided back to LMF logic 200. Rather, LMF logic 200 is configured to determine the location of mobile device 150 based on, for example, ranging data received from mobile device 150. Only after receipt of that ranging data is LMF logic 200 configured to calculate or determine the location of mobile device 150 based on the fixed asset coordinates previously supplied.

In this regard, having an address of, e.g., WLAN Controller 350 (or other device), server 550 sends, at 506, a request to WLAN Controller 350 requesting the coordinates of its associated APs 360 (or fixed assets 380, more generally, for corresponding RTLSs) that are distributed throughout space 130. At 508, WLAN Controller 350 responds to server 550 with the coordinates of its fixed assets 380 (or APs 360). These coordinates might be provided in any appropriate form and enable LMF logic 200 to recreate a map or a constellation of the fixed assets 380 (or APs 360).

Thereafter, at 510, server 550 may request ranging data from mobile device 150 for each RTLS method for which mobile device 150 is configured to support and for which LMF logic 200 has received corresponding fixed asset coordinates. In response to the request, and at 512, mobile device 150 provides the ranging data for each such RTLS method requested by server 550. The ranging data may include data such as that associated with the RTLS data sources 210 indicated in FIG. 2. Thus, for example, the ranging data supplied by mobile device 150 may include, among others, time of arrival, time difference of arrival, angle of arrival, RSSI, and FTM measurements, all suggestive of a position of mobile device 150 with respect to fixed assets 380 (or APs 360).

At 514, LMF logic 200 then processes the received ranging data information to determine the location of mobile device 150 using the fixed asset coordinates previously provided. Again, in comparison to the approach illustrated by FIG. 4, in the approach illustrated by FIG. 5, raw ranging data is requested and received from mobile device 150 and LMF logic 200 is configured to, based on the map or constellation of fixed assets 380/APs 360, determine a precise location of mobile device 150.

Notably, because mobile device 150 is configured to support MMFC, LMF logic 200 may obtain ranging/position data and/or location data from multiple RTLSs. LMF logic 200 may then be configured to “fuse” this data (or determined location based thereon) to obtain a more precise indication of the location of mobile device 150. That is, if ranging data is used to determine the location of mobile device 150, and if multiple ranging techniques are available, then one RTLS techniques could be used to validate another RTLS technique, the determined location of mobile device 150 based on two or more RTLS techniques could be averaged including weighting one RTLS technique more than another depending on relative accuracy of respective RTLS techniques, or one RTLS could simply be selected or relied upon over another.

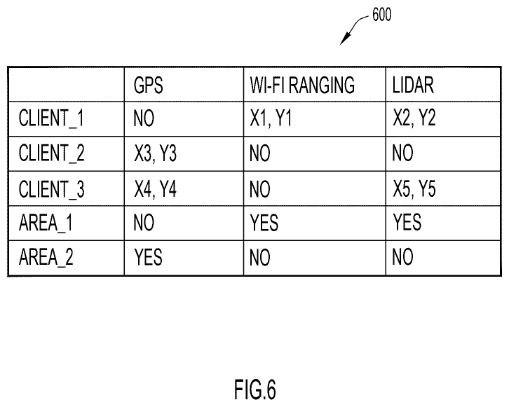

In this regard, FIG. 6 shows a database 600, e.g., converged location data database 220, that may be used by LMF logic 200 to select and/or fuse location information received or determined from information received from mobile device 150, according to an example embodiment. In this example, RTLSs methods of GPS, Wi-Fi ranging, and LIDAR are listed. Those skilled in the art will appreciate that other RTLS methods may be listed/stored as well. For each client device, Client_1, Client_2, Client_3, the database indicates whether data for a given RTLS technique is not available and, if it is available, the location based on that RTLS technique is listed. As an example, for Client_1, no GPS data is available, but Wi-Fi ranging-based and LIDAR-based locations were determined to be X1, Y1 and X2, Y2, respectively. In the case of Client_2, GPS location data is available and is indicated by X3, Y3. For Client_3, GPS location of X4, Y4 is available and LIDAR-based location of X5, Y5 is available. In this latter case, the LIDAR-based location may be ignored since GPS location may be considered more accurate.

Also shown in FIG. 6 are indications of whether given RTLS techniques are available in selected areas. Thus, for example, if it is known that mobile device 150 will be moving from Area_1 to Area_2, LMF logic 200 may no longer request ranging data from mobile device 150 since GPS location will be available. This can reduce unnecessary communication between the cellular network core and mobile device 150.

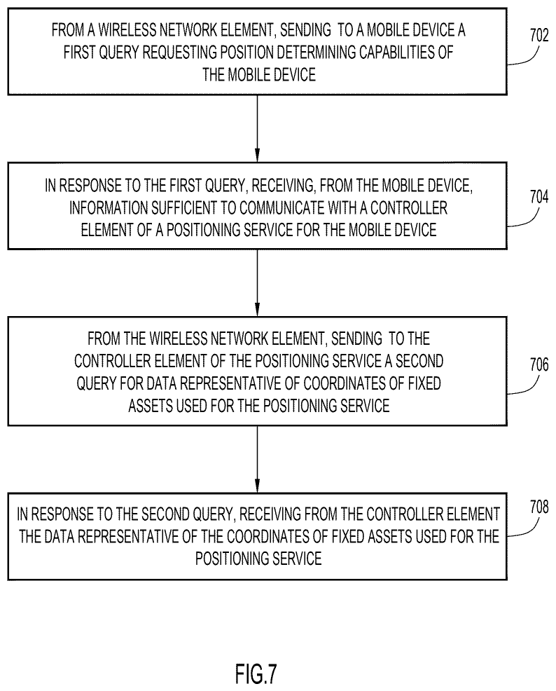

FIG. 7 is a flowchart depicting a series of steps that may be executed by location management function logic, according to an example embodiment. At 702, an operation includes, from a wireless network element, sending to a mobile device a first query requesting position determining capabilities of the mobile device. At 704, an operation includes, in response to the first query, receiving, from the mobile device, information sufficient to communicate with a controller element of a positioning service for the mobile device. At 706, an operation includes, from the wireless network element, sending to the controller element of the positioning service a second query for data representative of coordinates of fixed assets used for the positioning service. And, at 708, an operation includes, in response to the second query, receiving from the controller element the data representative of the coordinates of fixed assets used for the positioning service.

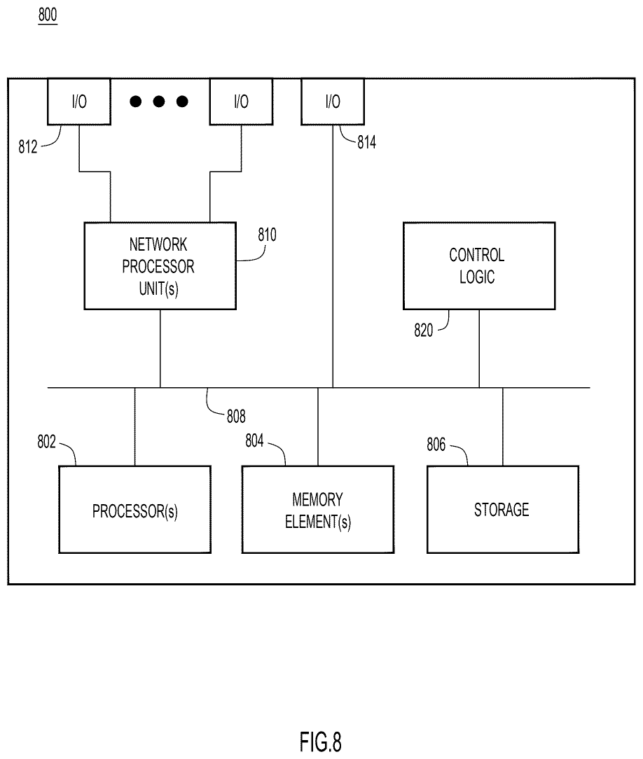

FIG. 8 is a block diagram of a computing device that may be configured to host location management function logic, and to perform techniques described herein, according to an example embodiment. In various embodiments, a computing device, such as computing device 800 or any combination of computing devices 800, may be configured as any entity/entities as discussed for the techniques depicted in connection with FIGS. 1-7 in order to perform operations of the various techniques discussed herein.

In at least one embodiment, the computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa) or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include from a wireless network element, sending a mobile device a first query to requesting position determining capabilities of the mobile device, in response to the first query, receiving, from the mobile device, information sufficient to communicate with a controller element of a positioning service for the mobile device, from the wireless network element, sending to the controller element of the positioning service a second query for data representative of coordinates of fixed assets used for the positioning service, and in response to the second query, receiving from the controller element the data representative of the coordinates of fixed assets used for the positioning service.

The method may further include sending to the mobile device a request for ranging data with respect to the fixed assets used for the positioning service.

The method may further include, in response to the request to the mobile device for ranging data, receiving, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.

The method may further include receiving, from the mobile device, information sufficient to contact respective controller elements of multiple positioning services for the mobile device.

The method may further include fusing position information received in connection with each of the multiple positioning services for the mobile device.

In the method, fusing position information may include at least one of validating, averaging, and weighting, the position information.

In the method, the wireless network element may comprise a Location Management Function of a Fifth Generation (5G) cellular network core.

In the method, the controller element of the positioning service for the mobile device may include a wireless local area network controller.

The method may further include receiving an indication of a location of the mobile device determined by a Global Positioning System.

The method may further include sending at least one of the first query and the second query via non-Access Stratum (NAS) signaling.

In another embodiment, a device may be provided and may include an interface configured to enable network communications, a memory, and one or more processors coupled to the interface and the memory, and configured to: send to a mobile device a first query requesting position determining capabilities of the mobile device, in response to the first query, receive, from the mobile device, information sufficient to communicate with a controller element of a positioning service for the mobile device, send to the controller element of the positioning service a second query for data representative of coordinates of fixed assets used for the positioning service, and in response to the second query, receive from the controller element the data representative of the coordinates of fixed assets used for the positioning service.

In the device, the one or more processors may be configured to send to the mobile device a request for ranging data with respect to the fixed assets used for the positioning service.

In the device, the one or more processors may be configured to, in response to the request to the mobile device for ranging data, receive, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.

In the device, the one or more processors may be configured to receive, from the mobile device, information sufficient to contact respective controller elements of multiple positioning services for the mobile device.

In the device, the one or more processors may be configured to fuse position information received in connection with each of the multiple positioning services for the mobile device.

In the device, the one or more processors may be configured to fuse position information by at least one of validating, averaging, and weighting, the position information.

In the device the one or more processors may be configured to send at least one of the first query and the second query via non-Access Stratum (NAS) signaling.

In yet another embodiment, one or more non-transitory computer readable storage media encoded with instructions are provided and that, when executed by a processor, cause the processor to: send to a mobile device a first query requesting position determining capabilities of the mobile device, in response to the first query, receive, from the mobile device, information sufficient to communicate with a controller element of a positioning service for the mobile device, send to the controller element of the positioning service a second query for data representative of coordinates of fixed assets used for the positioning service, and in response to the second query, receive from the controller element the data representative of the coordinates of fixed assets used for the positioning service.

The instructions may be configured to send to the mobile device a request for ranging data with respect to the fixed assets used for the positioning service.

The instructions may be configured to, in response to the request to the mobile device for ranging data, receive, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
from a wireless network element, sending to a mobile device a first query requesting position determining capabilities of the mobile device;
in response to the first query, receiving, from the mobile device, information sufficient to communicate with a controller element of a positioning service for the mobile device;
from the wireless network element, sending to the controller element of the positioning service a second query for data representative of coordinates of fixed assets used for the positioning service; and
in response to the second query, receiving from the controller element the data representative of the coordinates of fixed assets used for the positioning service.

2. The method of claim 1, further comprising sending to the mobile device a request for ranging data with respect to the fixed assets used for the positioning service.

3. The method of claim 2, further comprising, in response to the request to the mobile device for ranging data, receiving, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.

4. The method of claim 1, further comprising receiving, from the mobile device, information sufficient to contact respective controller elements of multiple positioning services for the mobile device.

5. The method of claim 4, further comprising fusing position information received in connection with each of the multiple positioning services for the mobile device.

6. The method of claim 5, wherein fusing position information comprises at least one of validating, averaging, and weighting, the position information.

7. The method of claim 1, wherein the wireless network element comprises a Location Management Function of a Fifth Generation (5G) cellular network core.

8. The method of claim 1, wherein the controller element of the positioning service for the mobile device comprises a wireless local area network controller.

9. The method of claim 1, further comprising receiving an indication of a location of the mobile device determined by a Global Positioning System.

10. The method of claim 1, further comprising sending at least one of the first query and the second query via non-Access Stratum (NAS) signaling.

11. A device comprising:
an interface configured to enable network communications;
a memory; and
one or more processors coupled to the interface and the memory, and configured to:
send to a mobile device a first query requesting position determining capabilities of the mobile device;
in response to the first query, receive, from the mobile device, information sufficient to communicate with a controller element of a positioning service for the mobile device;
send to the controller element of the positioning service a second query for data representative of coordinates of fixed assets used for the positioning service; and
in response to the second query, receive from the controller element the data representative of the coordinates of fixed assets used for the positioning service.

12. The device of claim 11, wherein the one or more processors are configured to send to the mobile device a request for ranging data with respect to the fixed assets used for the positioning service.

13. The device of claim 12, wherein the one or more processors are configured to, in response to the request to the mobile device for ranging data, receive, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.

14. The device of claim 11, wherein the one or more processors are configured to receive, from the mobile device, information sufficient to contact respective controller elements of multiple positioning services for the mobile device.

15. The device of claim 14, wherein the one or more processors are configured to fuse position information received in connection with each of the multiple positioning services for the mobile device.

16. The device of claim 15, wherein the one or more processors are configured to fuse position information by at least one of validating, averaging, and weighting, the position information.

17. The device of claim 11, wherein the one or more processors are configured to send at least one of the first query and the second query via non-Access Stratum (NAS) signaling.

18. One or more non-transitory computer readable storage media encoded with instructions that, when executed by a processor, cause the processor to:
send to a mobile device a first query requesting position determining capabilities of the mobile device;
in response to the first query, receive, from the mobile device, information sufficient to communicate with a controller element of a positioning service for the mobile device;
send to the controller element of the positioning service a second query for data representative of coordinates of fixed assets used for the positioning service; and
in response to the second query, receive from the controller element the data representative of the coordinates of fixed assets used for the positioning service.

19. The one or more non-transitory computer readable storage media of claim 18, wherein the instructions are configured to send to the mobile device a request for ranging data with respect to the fixed assets used for the positioning service.

20. The one or more non-transitory computer readable storage media of claim 19, wherein the instructions are configured to, in response to the request to the mobile device for ranging data, receive, from the mobile device, information associated with at least one of a signal Angle of Arrival, a signal Time Difference of Arrival, a Received Signal Strength Indicator value, and a Fine Timing Measurement value associated with at least one of the fixed assets used for the positioning service.
